(19) United States
(12) Patent Application Publication
(10) Pub. No.: US 2014/0045980 A1
(43) Pub. Date: Feb. 13, 2014

(54) ADDITIVES FOR HIGH-FLOW POLYMERS

(71) Applicants: Michele Gerster, Binningen (CH); Raphael Dabbous, Riehen (CH)

(72) Inventors: Michele Gerster, Binningen (CH); Raphael Dabbous, Riehen (CH)

(73) Assignee: BASF SE, LUDWIGSHAFEN (DE)

(21) Appl. No.: 14/113,072

(22) PCT Filed: Apr. 23, 2012
(86) PCT No.: PCT/IB12/52034

§ 371 Date: Oct. 21, 2013

Related U.S. Application Data
(60) Provisional application No. 61/478,954, filed on Apr. 26, 2011.

(30) Foreign Application Priority Data
Apr. 26, 2011 (EP) 11163666.8

(51) Int. Cl. C08K 5/527; C08K 5/098

(52) U.S. Cl. CPC C08K 5/527; C08K 5/098
USPC 524/141

(57) ABSTRACT

A composition containing (I) a natural or synthetic organic polymer having a melt flow index of 15 to 1000 g/10 min at 230° C. and 2.16 kg and (II) an additive mixture containing components (A1) and (A2), wherein (A1) is at least one organic cyclic phosphoric acid ester of the formula (I) (I) wherein Rₒ is a direct bond, —S—, C₃-C₁₂cycloalkylidene or a group —C(Xi)(X2)— with X₁ and X₂ independently of one another being hydrogen, C₁-C₁₈salkyl or C₃-C₁₂cycloalkyl; and the radicals R₁ are identical and are C₁-C₄alkyl or C₃-C₁₂cycloalkyl unsubstituted or substituted by one, two or three C₁-C₄alkyl; and (A2) is at least one alkali or alkaline earth metal salt of a saturated or unsaturated aliphatic mono or dicarboxylic acid unsubstituted or substituted by —OH; with the proviso that the composition is essentially free of an inorganic or organic pigment.

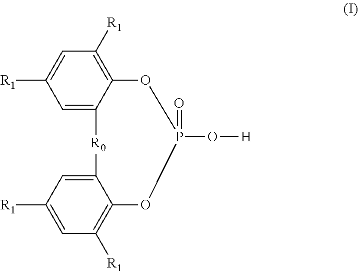

The present invention relates to a high-flow natural or synthetic organic polymer containing an additive mixture, to the corresponding masterbatch, to a method for nucleating a high-flow natural or synthetic organic polymer and to a method for reducing the haze value of such a polymer.

In the following polymers with a high melt flow index (MFI) are named as high-flow polymers.

In more detail, the present invention relates to a composition containing
(I) a natural or synthetic organic polymer having a melt flow index of 15 to 1000 g/10 min at 230° C. and 2.16 kg, and
(II) an additive mixture containing components (A1) and (A2), wherein
(A1) is at least one organic cyclic phosphoric acid ester of the formula (I)

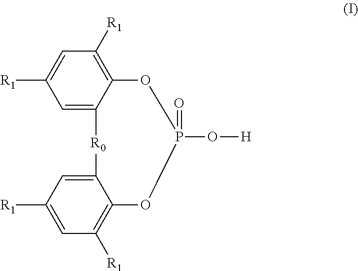

wherein R₀ is a direct bond, —S—, C₃-C₁₂cycloalkylidene or a group —C(X1)(X2)— with X₁ and X₂ independently of one another being hydrogen, C1-C₁₈alkyl or C₃-C₁₂cycloalkyl; and the radicals R₁ are identical and are C₁-C₁₈alkyl or C₃-C₁₂cycloalkyl unsubstituted or substituted by one, two or three C₁-C₄alkyl; and
(A2) is at least one alkali or alkaline earth metal salt of a saturated or unsaturated aliphatic mono or dicarboxylic acid unsubstituted or substituted by —OH;
   with the proviso that the composition is essentially free of an inorganic or organic pigment.

According to a further preferred embodiment of the present invention, the compositions are additionally free of a divalent metal alcoholate, in particular a divalent metal alcoholate wherein the metal is Zn, Ca or Mg.

The compounds of components (A1) and (A2) are known and can be prepared according to known methods, if not commercially available.

The compounds of the formula (I) can be prepared as described in e.g. U.S. Pat. No. 6,184,275.

The molar ratio of the components (A1) : (A2) is preferably 1:5 to 5:1, in particular 1:2 to 2:1, e.g. about 1:1.

A preferred example of C₃-C₁₂cycloalkylidene is the group

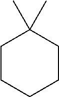

Examples of alkyl having up to 18 carbon atoms are methyl, ethyl, n-propyl, 1-methylethyl, n-butyl, 2-methylpropyl, 1-methylpropyl, tert-butyl, pentyl, 1-methylbutyl, 2-methylbutyl, 3-methylbutyl, 1,1-dimethylpropyl, 1-ethylpropyl, tert-butylmethyl, hexyl, 1-methylpentyl, heptyl, isoheptyl, 1-ethylhexyl, 2-ethylpentyl, 1-propylbutyl, octyl, nonyl, isononyl, neononyl, 2,4,4-trimethylpentyl, undecyl, tridecyl, pentadecyl, heptadecyl and octadecyl. Branched C₃-C₁₈alkyl, e.g. C₃-C₅ alkyl, in particular tert-butyl, is a preferred meaning of the radicals R₁.

An example of C₃-C₁₂cycloalkyl, preferably C₃-C₅cycloalkyl, is cyclohexyl.

An example of C₃-C₁₂cycloalkyl substituted by one, two or three C₁-C₄alkyl is α-methylcyclohexyl.

Component (A1) is preferably the compound of the formula (I-1) or (I-2)

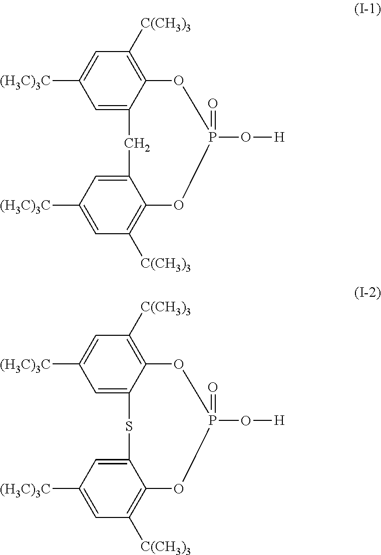

R₀ is preferably a direct bond, —S—, —CH₂— or —CH(C₁-C₁₈ alkyl)-; and

the radicals R₁ are preferably C₁-C₁₂alkyl, cyclohexyl or methylcyclohexyl.

Examples of a saturated or unsaturated aliphatic mono or dicarboxylic acid unsubstituted or substituted by —OH are capric acid, neodecanoic acid, undecanoic acid, lauric acid, tridecanoic acid, myristic acid, pentadecanoic acid, palmitic acid, margaric acid, stearic acid, nonadecanoic acid, arachidic acid, behenic acid, lignoceric acid, cerotic acid, montanoic acid, melissic acid, obtusilic acid, linderic acid, tsuzuic acid, palmitoleic acid, petroselinic acid, oleic acid, elaidic acid and vaccenic acid.

Lauric acid, myristic acid, stearic acid, montanoic acid and oleic acid are preferred.

Preferred examples of the alkali or earth alkaline metal cation of component (A2) are Li⁺, Na⁺, K⁺, Mg²⁺, Ca²⁺, Ba²⁺, Al³⁺ and Al(OH)²⁺.

According to a further preferred embodiment of the present invention component (A2) is a C₁₀-C₂₀alkanoate with the cation being Li⁺, Na⁺, K⁺, Mg²⁺, Ca²⁺, Ba²⁺, Al³⁺ or Al(OH)²⁺.

According to a particularly preferred embodiment (A2) is the Li salt of lauric acid, myristic acid, stearic acid, montanoic acid or oleic acid, in particular Li stearate.

According to a further particularly preferred embodiment of the present invention component (A1) is the compound of the formula (I-1) or (I-2),

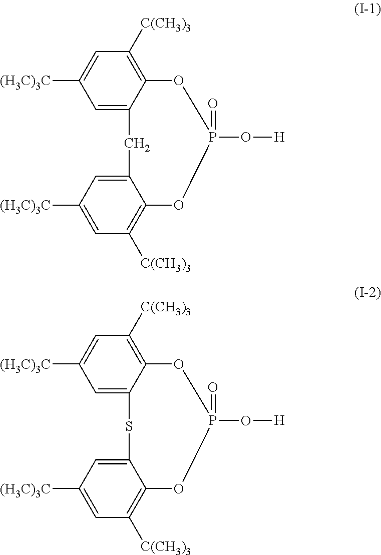

and component (A2) is Li stearate.

Component (I) has preferably a melt flow index of 20 to 200 g/10 min, in particular 20 to 100 g/10 min, e.g. 40 to 95 g/10 min, 20 to 95 g/10 min or 25 to 92 g/10 min, at 230° C. and 2.16 kg. The melt flow index can be determined in accordance with ASTM D1238.

According to a further preferred embodiment component (I) is a high-flow synthetic organic polymer, in particular a high-flow polyolefin, e.g. a high-flow polypropylene homopolymer, a high-flow random copolymer, a high-flow alternating or segmented co-polymer, a high-flow block copolymer or a high-flow blend of polypropylene with another synthetic organic polymer.

high-flow polypropylene homopolymer and high-flow random copolymers of polypropylene are most preferred.

The high-flow natural or synthetic organic polymers of component (I) are also known as controlled rheology grades (CR grades) and are commercially available or can be prepared according to known methods.

In more detail, high-flow polypropylene, also known as high MFI polypropylene, can be produced e.g. by two basic methods as described below:

1. Polymerisation control: This involves changing the polymerisation conditions to control the molecular weight of the final product. This method may lead to a high value of M_{w}/Mₙ, i.e. a broad molecular weight distribution. MFI values achievable by this method can range from e.g. 15 to 1000 g/10 min at 230° C. and 2.16 kg; polypropylene with the upper value may be used for high rate fibre production to give very soft fibres for non-woven fabric production.

2. Post-Treatment: This involves taking polypropylene from the reactor and subjecting it to a variety of treatments to break the main chain and reduce the molecular weight. This is a degradation treatment and can be achieved e.g. by:
a) Thermal mechanical treatment
b) Gamma radiation
c) Oxidation
d) addition of free radical initiator, such as organic peroxides or hindered amines, preferably hindered acyloxyamines.

Due to the decreased melt viscosity of CR grades the application of these materials is mainly in the following areas:
Thin walled packaging.
Straight sided and thin walled boxes.
Products requiring a long flow path.

CR grades show several processing advantages over conventional grades. The most significant of these are:

The decreased viscosity means less injection pressure is required for mould filling. Lower melt temperatures are required to achieve the same viscosity i.e. approximately 30° C. lower mass temperature.

Cycle times can generally be reduced by 10-15%.

Lower temperatures mean that warpage on demoulding is reduced.

Pigment/colour mixing may be improved due to decreased viscosity and better flow at a given temperature.

The decreased injection pressure may allow a machine with a lower clamping force to be used.

The additive mixture of component (II) is preferably present in an amount of 0.0001 to 5%, for example 0.001 to 5%, 0.001 to 2%, 0.005 to 1%, 0.01 to 1% or 0.01 to 0.5%, relative to the weight of component (I).

A further preferred embodiment of the present invention relates to a composition containing as additional component (III-1) e.g. 0.001 to 5%, preferably 0.01 to 5%, relative to the weight of component (I), of one or more conventional nucleating agents.

Examples of conventional nucleating agents are

1) Aromatic bis-acetals, for example
1,3:2,4-bis(benzylidene)sorbitol, commercially available as Irgaclear D (RTM), Millad 3905 (RTM) and Gel All D (RTM).
1,3:2,4-bis(4-methylbenzylidene)sorbitol, commercially available as Irgaclear DM (RTM), Millad 3940 (RTM), NC-6 (Mitsui (RTM)) and Gel All MD (RTM).
1,3:2,4-bis(3,4-dimethylbenzylidene)sorbitol, commercially available as Millad 3988 (RTM).
1,3:2,4-bis(4-ethylbenzylidene)sorbitol, commercially available as NC-4 (Mitsui (RTM)).
1,2,3-trideoxy-4,6:5,7-bis-O-[(4-propylphenyl)methylene]-nonitol, commercially available as Millad NX 8000 (RTM).

2) Nucleating agents based upon salts of carboxylic acid, for example sodium benzoate.

3) Nucleating agents based upon carboxy aluminum-hydroxide, for example aluminum hydroxy-bis[4-(tert-butyl)benzoate], commercially available as Sandostab 4030 (RTM).

4) Nucleating agents based upon salts of rosin, respectively abietic acid, for example
Pinecrystal KM-1300 (RTM).
Pinecrystal KM-1600 (RTM).

5) Di-sodium salt of cis-endo-bicyclo(2.2.1)heptane 2,3-dicarboxylic acid (=Chemical Abstracts Registry No. 351870-33-2), commercially available as Hyperform HPN-68 (RTM) and calcium salt of hexahydrophthalic acid, commercially available as Hyper-form HPN-20 E (RTM).

6) Zn glycerolate (CAS Registry No. 87189-25-1; for example commercially available as Prifer 3881 (RTM) or Prifer 3888 (RTM)).

The compositions according to the present invention have excellent processability (e.g. cycle time reduction during processing, higher throughput, low energy consumption, etc.) and crystallizability, good stiffness, high transmittance, high clarity, low haze and/or improved thermal stability. Further benefits that are achieved include less warpage, more uniform shrinkage and better drawdown characteristics.

Another embodiment of the present invention is a method for reducing the haze value of a natural or synthetic organic polymer having a melt flow index of 15 to 1000 g/10 min at 230° C. and 2.16 kg and being essentially free of an inorganic or organic pigment, which method comprises incorporating therein the additive mixture as defined above.

The haze may be determined according to ASTM D 1003. Haze is defined as that percentage transmitted light which in passing through a specimen (plate) deviates from the incident beam by more than 2.5° on the average. Clarity is evaluated in the angle range smaller than 2.5°. The specimen shall have substantially plane-parallel surfaces free of dust, grease, scratches, and blemishes, and it shall be free of distinct internal voids and particles.

Still another embodiment of the present invention relates to a method for increasing the crystallization temperature of a high-flow natural or synthetic organic polymer which is essentially free of an inorganic or organic pigment, which method comprises incorporating into the synthetic organic polymer the additive mixture as defined above. The crystallization temperature may be increased for example by more than 3° C., in particular more than 5° C. An increase of the crystallization temperature of 4 to 30° C., e.g. 4 to 25° C. or 4 to 20° C., is especially preferred. Thus, the present invention also relates to a method for nucleating a natural or synthetic organic polymer having a melt flow index of 15 to 1000 g/10 min at 230° C. and 2.16 kg and being essentially free of an inorganic or organic pigment, which method comprises incorporating therein the additive mixture as defined above.

The compositions of the present invention may be prepared by standard procedures, well known to those skilled in the art, of compounding, such as mixing the prescribed components in a conventional mixer and melting and kneading the mixture with a single- or twin-screw extruder, or the like.

Component (II) of the present invention (additive mixture) can be added to the high-flow natural or synthetic organic polymer by using any technology known in the art, e.g. in the form of a powder, granules, concentrates, spray coatings or masterbatches, which contain these compounds in a concentration of, for example, 1 to 50%, in particular 1 to 10% by weight, either in pure form or along with other co-additives and optionally suitable carrier materials according to well known and established technologies.

Additional materials, e.g. compatible polymers, modifiers or additives, can optionally be added to the compositions of the present invention in a concentration range that does not adversely affect the beneficial effects of the invention. A concentration range of 0.001 to 10%, in particular 0.001 to 1%, relative to the material to be stabilized, is preferred. These additives may include stabilizers, antioxidants, antibacterial agents, ultra-violet absorbers, thermostabilizers, light stabilizers, neutralizers, antistatic agents, antiblocking agents, heavy metal inactivation agents, flame retardants, peroxides, hydro-talcite, foaming agents, elastomers, additional nucleating agents, and the like and mixtures thereof.

More detailed examples of these conventional additives are listed below.

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis (3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, di-octadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenyl-amine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

2. UV absorbers and light stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

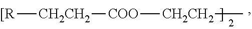

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; 2-2′-hydroxy-3′-(1,1,3,3-tetramethylbutyl)-5′-(α,α-dimethylbenzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.

2.5. Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)pethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 242-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 242-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-di-methylphenyl)-1,3,5-triazine, 2,4-bis(442-ethylhexyloxy]-2-hydroxyphenyl)-6-(4-methoxyphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bi-sphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxy-pentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos 168, Ciba Specialty Chemicals Inc.), tris(nonylphenyl) phosphite,

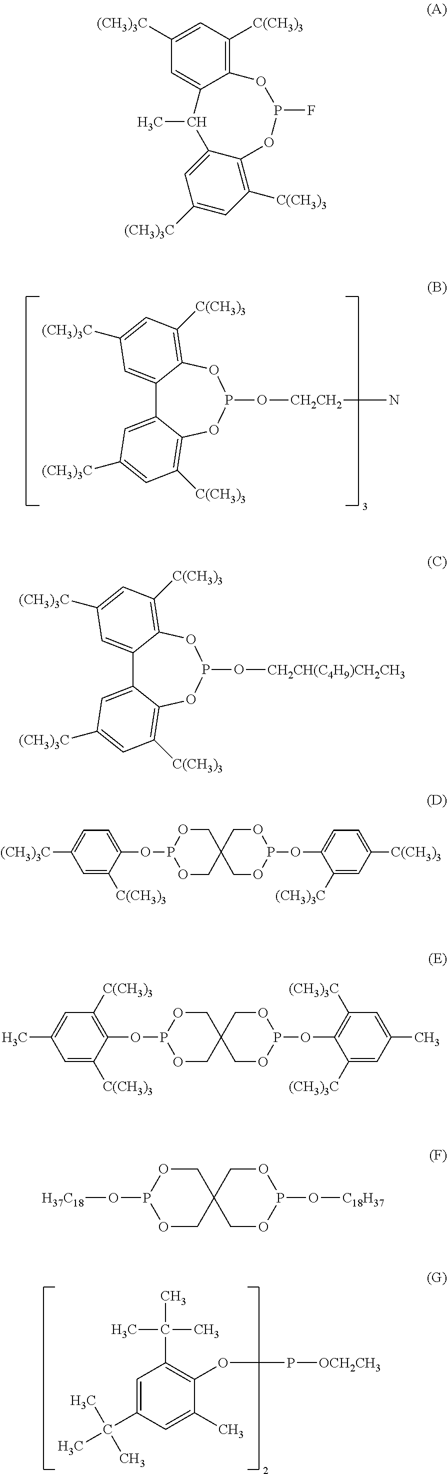

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydro-genated tallow amine.

7. Thiosynergists, for example dilauryl thiodipropionate, dimistryl thiodipropionate, distearyl thiodipropionate or distearyl disulfide.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(13-dodecylmercapto)propionate.

9. Polyamide stabilizers, for example copper salts in combination with iodides and/or phosphorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol. Of particular interest are those listed above for component C-1).

12. Fillers and reinforcing agents, for example calcium carbonate, silicates, surface treated silica (as described e.g. in US-A-2007/60,697 and US-A-2009/111,918), glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, catalysts, optical brighteners, flameproofing agents, antistatic agents and blowing agents. 14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

A preferred embodiment of the present invention relates to a composition containing as additional component

(III-2) one or more sterically hindered amine compounds.

Preferred examples of these sterically hindered amine compounds are those listed above under item 2.6. The combined use of components (II) and (III-2) can even lead to an effect in further reducing the haze of a crystallizable polymer. Component (III-2) is preferably used in an amount of 5-70%, more preferably 10-30% and most preferably 15-25%, relative to the weight of component (II).

Examples of processing of the compositions according to the present invention are: Injection blow molding, extrusion, blow molding, rotomolding, in mold decoration (back injection), slush molding, injection molding, co-injection molding, forming, compression molding, pressing, film extrusion (cast film; blown film), fiber spinning (woven, non-woven), drawing (uniaxial, biaxial), annealing, deep drawing, calandering, mechanical transformation, sintering, coextrusion, coating, lamination, crosslinking (radiation, peroxide, silane), vapor deposition, weld together, glue, vulkanization, thermoforming, pipe extrusion, profile extrusion, sheet extrusion; sheet casting, spin coating, strapping, foaming, recycling/rework, extrusion coating, visbreaking (peroxide, thermal), fiber melt blown, spun bonded, surface treatment (corona discharge, flame, plasma), sterilization (by gamma rays, electron beams), gel-coating, tape extrusion, SMC-process or plastisol.

The compositions according to the present invention can be advantageously used for the preparation of various shaped articles. Examples are:

I-1) Floating devices, marine applications, pontoons, buoys, plastic lumber for decks, piers, boats, kayaks, oars, and beach reinforcements.

I-2) Automotive applications, in particular bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.

I-3) Road traffic devices, in particular sign postings, posts for road marking, car accessories, warning triangles, medical cases, helmets, tires.

I-4) Devices for plane, railway, motor car (car, motorbike) including furnishings.

I-5) Devices for space applications, in particular rockets and satellites, e.g. reentry shields.

I-6) Devices for architecture and design, mining applications, acoustic quietized systems, street refuges, and shelters.

II-1) Appliances, cases and coverings in general and electric/electronic devices (personal computer, telephone, portable phone, printer, television-sets, audio and video devices), flower pots, satellite TV bowl, and panel devices.

II-2) Jacketing for other materials such as steel or textiles.

II-3) Devices for the electronic industry, in particular insulation for plugs, especially computer plugs, cases for electric and electronic parts, printed boards, and materials for electronic data storage such as chips, check cards or credit cards.

II-4) Electric appliances, in particular washing machines, tumblers, ovens (microwave oven), dish-washers, mixers, and irons.

II-5) Covers for lights (e.g. street-lights, lamp-shades).

II-6) Applications in wire and cable (semi-conductor, insulation and cable-jacketing).

II-7) Foils for condensers, refrigerators, heating devices, air conditioners, encapsulating of electronics, semi-conductors, coffee machines, and vacuum cleaners.

III-1) Technical articles such as cogwheel (gear), slide fittings, spacers, screws, bolts, handles, and knobs.

III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.

III-3) Sanitary articles, in particular shower cubicles, lavatory seats, covers, and sinks.

III-4) Hygienic articles, in particular diapers (babies, adult incontinence), feminine hygiene articles, shower curtains, brushes, mats, tubs, mobile toilets, tooth brushes, and bed pans.

III-5) Pipes (cross-linked or not) for water, waste water and chemicals, pipes for wire and cable protection, pipes for gas, oil and sewage, guttering, down pipes, and drainage systems.

III-6) Profiles of any geometry (window panes) and siding.

III-7) Glass substitutes, in particular extruded plates, glazing for buildings (monolithic, twin or multiwall), aircraft, schools, extruded sheets, window film for architectural glazing, train, transportation, sanitary articles, and greenhouse.

III-8) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.

III-9) Intake and outlet manifolds.

III-10) Cement-, concrete-, composite-applications and covers, siding and cladding, hand rails, banisters, kitchen work tops, roofing, roofing sheets, tiles, and tarpaulins.

IV-1) Plates (walls and cutting board), trays, artificial grass, astroturf, artificial covering for stadium rings (athletics), artificial floor for stadium rings (athletics), and tapes.

IV-2) Woven fabrics continuous and staple, fibers (carpets/hygienic articles/geotex-tiles/monofilaments; filters; wipes/curtains (shades)/medical applications), bulk fibers (applications such as gown/protection clothes), nets, ropes, cables, strings, cords, threads, safety seat-belts, clothes, underwear, gloves; boots; rubber boots, intimate apparel, garments, swimwear, sportswear, umbrellas (parasol, sunshade), parachutes, paraglides, sails, “balloon-silk”, camping articles, tents, airbeds, sun beds, bulk bags, and bags.

IV-3) Membranes, insulation, covers and seals for roofs, tunnels, dumps, ponds, dumps, walls roofing membranes, geomembranes, swimming pools, curtains (shades)/sun-shields, awnings, canopies, wallpaper, food packing and wrapping (flexible and solid), medical packaging (flexible & solid), airbags/safety belts, arm—and head rests, carpets, centre console, dashboard, cockpits, door, overhead console module, door trim, headliners, interior lighting, interior mirrors, parcel shelf, rear luggage cover, seats, steering column, steering wheel, textiles, and trunk trim.

V) Films (packaging, dump, laminating, agriculture and horticulture, greenhouse, mulch, tunnel, silage), bale wrap, swimming pools, waste bags, wallpaper, stretch film, raffia, desalination film, batteries, and connectors.

VI-1) Food packing and wrapping (flexible and solid), BOPP, BOPET, bottles.

VI-2) Storage systems such as boxes (crates), luggage, chest, household boxes, pallets, shelves, tracks, screw boxes, packs, and cans.

VI-3) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister.

VII-1) Extrusion coating (photo paper, tetrapack, pipe coating), household articles of any kind (e.g. appliances, thermos bottle/clothes hanger), fastening systems such as plugs, wire and cable clamps, zippers, closures, locks, and snap-closures.

VII-2) Support devices, articles for the leisure time such as sports and fitness devices, gymnastics mats, ski-boots, inline-skates, skis, big foot, athletic surfaces (e.g. tennis grounds); screw tops, tops and stoppers for bottles, and cans.

VII-3) Furniture in general, foamed articles (cushions, impact absorbers), foams, sponges, dish clothes, mats, garden chairs, stadium seats, tables, couches, toys, building kits (boards/figures/balls), playhouses, slides, and play vehicles.

VII-4) Materials for optical and magnetic data storage.

VII-5) Kitchen ware (eating, drinking, cooking, storing).

VII-6) Boxes for CD's, cassettes and video tapes; DVD electronic articles, office supplies of any kind (ball-point pens, stamps and ink-pads, mouse, shelves, tracks), bottles of any volume and content (drinks, detergents, cosmetics including perfumes), and adhesive tapes.

VII-7) Footwear (shoes/shoe-soles), insoles, spats, adhesives, structural adhesives, food boxes (fruit, vegetables, meat, fish), synthetic paper, labels for bottles, couches, artificial joints (human), printing plates (flexographic), printed circuit boards, and display technologies.

VII-8) Devices of filled polymers (talc, chalk, china clay (kaolin), wollastonite, pigments, carbon black, TiO2, mica, nanocomposites, dolomite, silicates, glass, asbestos).

Thus, a further preferred embodiment of the present invention relates to a shaped article, in particular a film, fiber, profile, pipe, bottle, tank or container, obtainable from a composition as described above.

A molded article is e.g. obtained by injection-molding, blow-molding, compression-molding, roto-molding, slush-molding and the like.

Another embodiment of the present invention relates to a monoaxially-oriented film or a biaxially-oriented film obtainable from a composition as described above.

The present invention further relates to a multilayer system in which one or more layers contain a composition as described above.

Still another embodiment of the present invention relates to a masterbatch, preferably obtained by low shear melt processing, containing a high-flow natural or synthetic organic polymer, preferably a polyolefin, and 0.5% to 5%, relative to the weight of the natural or synthetic organic polymer, of components (A1) and (A2) as defined above, characterized in that the molar ratio of components (A1):(A2) is 1:5 to 5:1, preferably 1:2 to 2:1, e.g. about 1:1, with the proviso that the masterbatch is essentially free of an inorganic or organic pigment.

A further preferred embodiment of the present invention relates to a method for producing an additivated high-flow natural or synthetic organic polymer which is essentially free of an inorganic or organic pigment, which method comprises incorporating therein 1% to 50% of the masterbatch as defined above.

An additional embodiment of the present invention relates to a method for improving the mechanical properties, e.g. charpy notched impact strength or flexural modulus, of a natural or synthetic organic polymer which is essentially free of an inorganic or organic pigment, which method comprises incorporating therein the additive mixture as defined above.

The following examples describe the present invention in more detail. All parts and percentages are given by weight unless indicated otherwise.

The following compounds of the formula (I) are used in the examples described below:

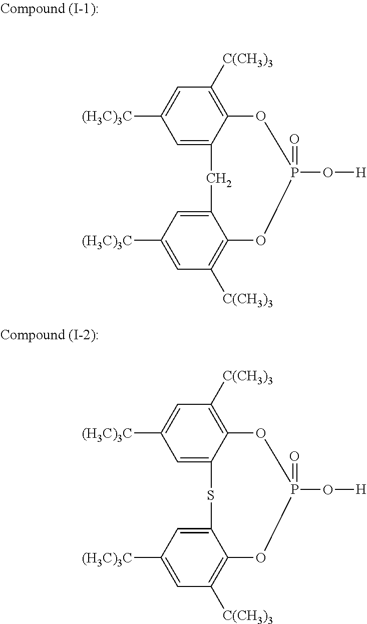 [SMILES: CC(C)(C)c1cc2c(c(C(C)(C)C)c1)OP(=O)(O)Oc1c(cc(C(C)(C)C)cc1C(C)(C)C)C2 ; CC(C)(C)c1cc2c(c(C(C)(C)C)c1)OP(=O)(O)Oc1c(cc(C(C)(C)C)cc1C(C)(C)C)S2]

The following Test Methods are Used in the Examples Described Below:

Optical Characterization (Haze):

The haze values are measured with a Haze-Gard Plus instrument (BYK Gardner (RTM), with illumination CIE-C) at room temperature in compliance with ASTM D-1003 at 1 mm thickness of the specimen. All haze values are measured at least 24 hours after injection molding of the samples, i.e. after equilibration of the “PP” at ambient conditions during at least one day. All haze data herein are given in percent for the haze percentage of disks with 1.0 mm thickness.

The results are summarized in the following Tables A-1 to A-4. Low haze values and high crystallization temperatures are desired.

Differential Scanning Calorimetry (DSC):

A Mettler-Toledo (RTM) instrument, Model DSC 820, operated under dry nitrogen atmosphere, is used for the analysis of the crystallization behavior of the various test samples and reference materials according to strictly computerized procedures as follows:

5 to 10 mg of sample are accurately weighed into an aluminum crucible; then, sealed with a 4-fold perforated lid. At constant heating or cooling rate of 10° C./min, the temperature program is run twice (first run just to erase the thermal history) from 30° C. to 240° C., keeping 240° C. for 3 min with subsequent cooling to 30° C. The data reported herein as crystallization temperatures “T_{c} [° C.]” represent the peak temperatures of the DSC exotherms during the second cooling cycle.

Charpy Impact Strength:

The Charpy Impact Strength was measured according to DIN EN ISO 179.

Flexural Modulus:

The Flexural Modulus was measured according to EN ISO 178.

### EXAMPLE 1

Compounding and Injection Molding:

Powdery propylene random copolymer “PP raco” supplied by Borealis (commercial type RD-204 CF (RTM), melt flow index=8 g/10 min at 230° C., 2.16 kg) is mixed with 0.05%, resp. 0.1% of 2,5-dimethyl-2,5-di(tert-butylperoxy)hexane, and vis-broken in a co-rotating twin screw extruder Berstorff (screw diameter 25 mm, L/D 46) at 250° C. The resulting products are “PP raco-MFI 42” (melt flow rate=42 g/10 min at 230° C., 2.16 kg) and “PP raco-MFI 92” (melt flow rate=92 g/10 min at 230° C., 2.16 kg).

Further high-flow polymers can be prepared in analogy to the method described above.

The vis-broken “PP raco-MFI 42” or “PP raco-MFI 92” is pre-mixed with the respective additives at the concentrations given in the tables herein. “%” means “% by weight” relative to the indicated polymer. Under constant nitrogen purge, the mixture is then intensely melt-compounded at the temperature given in the respective Table, for 3 min at 100 rpm screw speed using a co-rotating laboratory twin-screw extruder, such as the 15 cm³ Micro-Compounder of DSM Xplore (RTM).

For the purpose of shape giving, the homogeneous melt is subsequently transferred to a 10 cm³ Micro-Injector (DSM Xplore (RTM)), where the melt is injected into a polished mold at a pressure of about 4 bars at 50° C. mold temperature. The resulting specimens have a diameter of 40 mm and a thickness of 1.0 mm.

These circular disks are used to characterize the properties of the nucleated polymer, typically by quantification of the optical properties, such as haze according to ASTM-1003 at 1 mm.

The results obtained are indicated in Tables A-1 to A-5.

TABLE A-1
Haze value of injection molded “PP raco-MFI 42” nucleated
with the indicated compound and processed at 190° C.

| Compound | Haze [%] |
|---|---|
| — | 50.2 |
| 0.060% of Compound (I-1) and | 32.5 |
| 0.036% of Li stearate | |
| 0.120% of Compound (I-1) and | 26.7 |
| 0.072% of Li stearate | |

Compound (I-1) and Li stearate are applied in a molar ratio of 1:1.

TABLE A-2
Haze value of injection molded “PP raco-MFI 92” nucleated
with the indicated compound and processed at 190° C.

| Compound | Haze [%] |
|---|---|
| — | 53.4 |
| 0.060% of Compound (I-1) and | 42.4 |
| 0.036% of Li stearate | |
| 0.120% of Compound (I-1) and | 38.3 |
| 0.072% of Li stearate | |

Compound (I-1) and Li stearate are applied in a molar ratio of 1:1.

TABLE A-3
Haze value of injection molded polypropylene homopolymer
(Moplen HP552 R (RTM) supplied by LyondellBasell; melt flow
index = 25 g/10 min, at 230° C., 2.16 kg) nucleated
with the indicated compound and processed at 210° C.

| Compound | Haze [%] |
|---|---|
| — | 67.6 |
| 0.060% of Compound (I-1) and | 35.6 |
| 0.036% of Li stearate | |
| 0.120% of Compound (I-1) and | 26.8 |
| 0.072% of Li stearate | |
| 0.180% of Compound (I-1) and | 23.5 |
| 0.110% of Li stearate | |
| 0.060% of Compound (I-2) and | 34.6 |
| 0.035% of Li stearate | |
| 0.120% of Compound (I-2) and | 28.8 |
| 0.069% of Li stearate | |
| 0.180% of Compound (1-2) and | 25.6 |
| 0.104% of Li stearate | |

TABLE A-4
Haze value of injection molded polypropylene homopolymer
Moplen HP552 R (RTM) supplied by LyondellBasell (melt flow
index = 25 g/10 min, at 230° C., 2.16 kg), nucleated
with the indicated compound and processed at 240° C.

| Compound | Haze [%] |
|---|---|
| — | 55.6 |
| 0.120% of Compound (I-1) and | 30.5 |
| 0.072% of Li stearate | |

TABLE A-5
Tc (crystallization temperature) of injection molded “PP raco-MFI 42”
nucleated with the indicated compound and processed at 190° C.

| | Increase in Tc versus non nucleated |
|---|---|
| Compound | “PP raco-MFI 42”in ° C. |
| 0.120% of Compound (I-1) and | 15.7 |
| 0.072% of Li stearate | |

### EXAMPLE 2

Compounding and Injection Molding:

First, a pre-mixture of the Compound (I-1) and Li stearate is made in a small high speed mixer. Then, a mixture of the additive pre-mixture plus a small quantity of powdery propylene random copolymer “PP raco” supplied by Borealis (commercial type RD-204 CF (RTM); melt flow index=8 g/10 min at 230° C., 2.16 kg) is obtained by slow speed mixing. Subsequently, a second pre-mixture of 2,5-dimethyl-2,5-di(tert-butylperoxy)hexane plus a small quantity of “PP raco” powder is made by slow speed mixing. Finally, a mixture of both above pre-mixtures, plus the rest of the “PP-raco” powder, is obtained in a bigger scale high speed mixer. The concentration of 2,5-dimethyl-2,5-di(tert-butylperoxy)hexane in the final mixture is 0.05%.

The mixture is extruded in a Berstorff twin screw extruder (25 mm, L/D 46) at 230° C. The extruded polymer has a melt flow index ˜42 g/10 min at 230° C., 2.16 kg and is denominated “PP raco-MFI 42” hereafter. Further to that, plaques of 1 mm and 2 mm thickness are obtained by injection molding on an Arburg 320 S, at 180° C., at 200° C., and at 230° C. In addition, ISO B bars (80 mm×10 mm×4 mm) are also obtained by injection molding on an Arburg 320 S, at 200° C. and at 230° C.

The haze is measured on the injected plaques. The Charpy Impact Strength and the Flexural Modulus are measured on the injected ISO bars.

The results obtained are indicated in Tables B-1 to B-4.

TABLE B-1
Haze value of injection molded “PP raco-MFI 42” nucleated with the
indicated compound. Plaques of 1 mm thickness.

| | Haze [%] | Haze [%] | Haze [%] |
|---|---|---|---|
| | (injection | (injection | (injection |
| | temperature | temperature | temperature |
| Compound | 180° C.) | 200° C.) | 230° C.) |
| — | 48.3 | 54.2 | 59.0 |
| 0.038% of Compound (I-1) | 30.3 | 36.4 | 38.7 |
| and 0.022% of Li stearate | | | |
| 0.076% of Compound (I-1) | 23.1 | 26.9 | 27.6 |
| and 0.044% of Li stearate | | | |

TABLE B-2
Haze value of injection molded “PP raco-MFI 42” nucleated with the
indicated compound. Plaques of 2 mm thickness.

| | Haze [%] | Haze [%] | Haze [%] |
|---|---|---|---|
| | (injection | (injection | (injection |
| | temperature | temperature | temperature |
| Compound | 180° C.) | 200° C.) | 230° C.) |
| — | 79.8 | 77.7 | 76.6 |
| 0.038% of Compound (I-1) | 66.6 | 68.0 | 70.0 |
| and 0.022% of Li stearate | | | |
| 0.076% of Compound (I-1) | 55.3 | 57.5 | 58.2 |
| and 0.044% of Li stearate | | | |

TABLE B-3
Flexural Modulus of injection molded “PP raco-MFI 42”
nucleated with the indicated compound.

| | Flexural | Flexural |
|---|---|---|
| | Modulus | Modulus |
| | [MPa] | [MPa] |
| | (injection | (injection |
| | temperature | temperature |
| Compound | 200° C.) | 230° C.) |
| — | 870.0 | 989.7 |
| 0.038% of Compound (I-1) and | 1148.0 | 1135.5 |
| 0.022% of Li stearate | | |
| 0.076% of Compound (I-1) and | 1187.8 | 1203.0 |
| 0.044% of Li stearate | | |

TABLE B-4
Charpy Impact Strength of injection molded “PP raco-MFI 42”
nucleated with the indicated compound.

| | Charpy Impact | Charpy Impact |
|---|---|---|
| | Strength | Strength |
| | [kJ/m2] | [kJ/m2] |
| | (injection | (injection |
| | temperature | temperature |
| Compound | 200° C.) | 230° C.) |
| — | 3.0 | 3.1 |
| 0.038% of Compound (I-1) and | 3.6 | 3.5 |
| 0.022% of Li stearate | | |
| 0.076% of Compound (I-1) and | 3.6 | 3.4 |
| 0.044% of Li stearate | | |

The results show that the additive mixture of the present invention can be used in vis-broken polypropylene, and that the produced compositions have improved optical and mechanical properties.

1. A composition containing
(I) a natural or synthetic organic polymer having a melt flow index of 15 to 1000 g/10 min at 230° C. and 2.16 kg and
(II) an additive mixture containing components (A1) and (A2), wherein
(A1) is at least one organic cyclic phosphoric acid ester of formula (I) 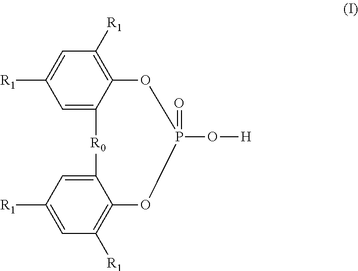
wherein R₀ is a direct bond, —S—, C₃-C₁₂cycloalkylidene or a group —C(X₁)(X₂)— where X₁ and X₂ independently of one another are hydrogen, C₁-C₁₈alkyl or C₃-C₁₂cycloalkyl; and the radicals R₁ are identical and are C₁-C₁₈alkyl or C₃-C₁₂cycloalkyl unsubstituted or substituted by one, two or three C₁-C₄alkyl; and
(A2) is at least one alkali or alkaline earth metal salt of a saturated or unsaturated aliphatic mono or dicarboxylic acid unsubstituted or substituted by —OH;
with the proviso that the composition is essentially free of an inorganic or organic pigment.

2. A composition according to claim 1 wherein R₀ is a direct bond, —S—, —CH₂— or —CH(C₁-C₁₈alkyl)-; and
the radicals R₁ are C₁-C₁₂alkyl, cyclohexyl or methylcyclohexyl.

3. A composition according to claim 1 wherein component (A1) is the compound of formula (I-1) or (I-2)

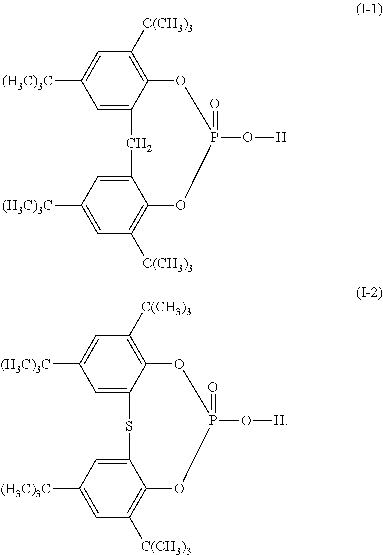

4. A composition according to claim 1 wherein the alkali or earth alkaline metal cation of component (A2) is Li⁺, Na⁺, K⁺, Mg²⁺, Ca²⁺, Ba²⁺, Al³⁺ or Al(OH)²⁺.

5. A composition according to claim 1 wherein component (A2) is a C₁₀-C₂₀alkanoate where the cation is Li⁺, Na⁺, K⁺, Mg²⁺, Ca²⁺, Ba²⁺, Al³⁺ or Al(OH)²⁺.

6. A composition according to claim 1 (A2) is Li stearate.

7. A composition according to claim 1 wherein component (A1) is the compound of formula (I-1) or (I-2) and 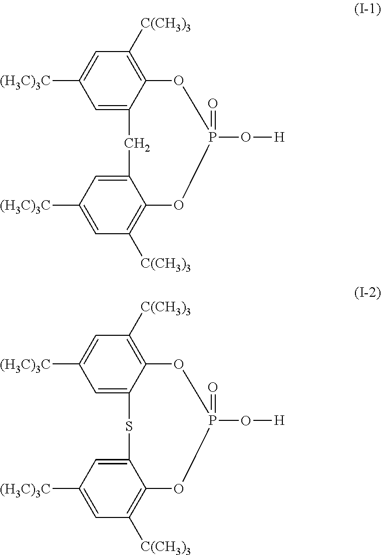
component (A2) is Li stearate.

8. A composition according to claim 1 wherein component (I) is a polyolefin having a melt flow index of 20 to 200 g/10 min at 230° C. and 2.16 kg.

9. A composition according to claim 1 wherein component (I) is a polypropylene homopolymer or propylene random copolymer having a melt flow index of 20 to 95 g/10 min at 230° C. and 2.16 kg.

10. A method for reducing the haze value of a natural or synthetic organic polymer having a melt flow index of 15 to 1000 g/10 min at 230° C. and 2.16 kg and being essentially free of an inorganic or organic pigment, which comprises incorporating therein
(II) an additive mixture containing components (A1) and (A2), wherein
(A1) is at least one organic cyclic phosphoric acid ester of formula (I) 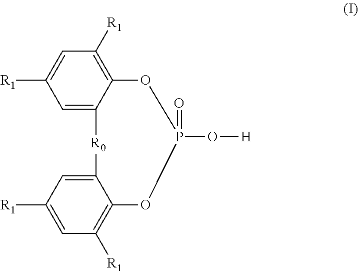
wherein R₀ is a direct bond, —S—, C₃-C₁₂cycloalkylidene or a group —C(X₁)(X₂)— where X₁ and X₂ independently of one another are hydrogen, C₁-C₁₈alkyl or C₃-C₁₂cycloalkyl; and the radicals R₁ are identical and are C₁-C₁₈alkyl or C₃-C₁₂cycloalkyl unsubstituted or substituted by one, two or three C₁-C₄alkyl; and
(A2) is at least one alkali or alkaline earth metal salt of a saturated or unsaturated aliphatic mono or dicarboxylic acid unsubstituted or substituted by —OH.

11. A method for nucleating a natural or synthetic organic polymer having a melt flow index of 15 to 1000 g/10 min at 230° C. and 2.16 kg and being essentially free of an inorganic or organic pigment, which comprises incorporating therein
(II) an additive mixture containing components (A1) and (A2), wherein
(A1) is at least one organic cyclic phosphoric acid ester of formula (I) 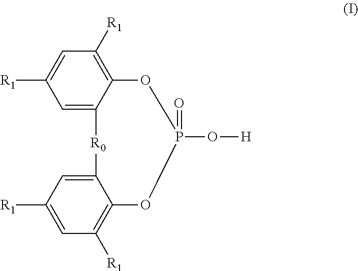
wherein R₀ is a direct bond, —S—, C₃-C₁₂cycloalkylidene or a group —C(X₁)(X₂)— where X₁ and X₂ independently of one another are hydrogen C₁-C₁₈alkyl or C₃-C₁₂cyclolkyl; and the radicals R₁ are identical and are C₁-C₁₈alkyl or C₃-C₁₂cycloalkyl unsubstituted or substituted by one, two or three C₁-C₄alkyl; and
(A2) is at least one alkali or alkaline earth metal salt of a saturated or unsaturated aliphatic mono or dicarboxylic acid unsubstituted or substituted by —OH.

12. A molded article made of a composition as defined in claim 1.

13. A composition according to claim 1 which is a masterbatch containing
(I) a natural or synthetic organic polymer having a melt flow index of 15 to 1000 g/10 min at 230° C. and 2.16 kg and
(II) 0.5% to 5%, relative to the weight of component (I), of components (A1) and (A2) where the molar ratio of components (A1):(A2) is 1:5 to 5:1;
with the proviso that the masterbatch is essentially free of an inorganic or organic pigment.

14. A masterbatch according to claim 13 wherein component (A1) is a compound of formula (I-1) or (I-2) and 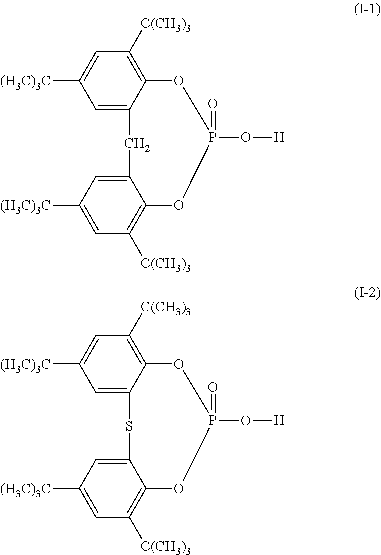
component (A2) is Li stearate.

15. A method for producing an additivated natural or synthetic organic polymer having a melt flow index of 15 to 1000 g/10 min at 230° C. and 2.16 kg and being essentially free of an inorganic or organic pigment, which comprises incorporating therein 1% to 50% of the masterbatch as defined in claim 13.

16. A thin-walled injection-molded article made of a composition as defined in claim 1.

17. A composition according to claim 3 wherein the alkali or earth alkaline metal cation of component (A2) is Li⁺, Na⁺, K⁺, Mg²⁺, Ca²⁺, Ba²⁺, Al³⁺or Al(OH)²⁺.

18. A composition according to claim 3 wherein component (A2) is a C₁₀-C₂₀alkanoate where the cation is Li⁺, Na⁺, K⁺, Mg²⁺, Ca²⁺, Ba²⁺, Al³⁺ or Al(OH)²⁺.
